(19) United States
(12) Patent Application Publication
(10) Pub. No.: US 2015/0168808 A1
(43) Pub. Date: Jun. 18, 2015

(54) DETACHABLE VIEWFINDER

(71) Applicant: Earl J. PeQueen, Watsonville, CA (US)

(72) Inventor: Earl J. PeQueen, Watsonville, CA (US)

(21) Appl. No.: 14/107,376

(22) Filed: Dec. 16, 2013

(51) Int. Cl. G03B 13/02; H04N 5/225

(52) U.S. Cl. CPC G03B 13/02; H04N 5/2254

(57) ABSTRACT

A viewfinder for a cellular telephone has a planar base having an upper and a lower surface, a pin affixed in the lower surface of the planar base, the pin having an axis extending substantially at a right angle to the plane of the base, the pin having a diameter and a length to fit in an audio port of a cellular telephone, a planar vertical element joined at substantially a right angle to one end of the planar base, the vertical element extending in the same direction as the axis of the pin, and a viewport affixed to the upper surface of the planar base, the viewport having a central axis extending substantially parallel to the upper surface of the planar base, the axis oriented in a direction at a right angle to the plane of the planar vertical element.

### BACKGROUND OF THE INVENTION

1. Field of the Invention

The present invention is in the technical field of image-capturing devices, such as cameras, and pertains more particularly to detachable viewfinders for such devices.

2. Description of Related Art

Since the advent of digital imaging, image-capture ability has been added to more and more devices. At the time of filing this patent application there is a very broad selection of commercially-available digital cameras, and most cellular telephones have digital image-capture ability. In the case of many digital cameras and cell phones, one may refer to the digital display to see what the camera will capture as a still or as video frames if the camera function is activated, typically by operating a button switch. The digital display, however is sometimes a bit clumsy to see while training the camera lens on a scene to capture, and in the case of bright sunlight, for example, may be difficult to see. Many devices have a viewfinder, but there are many that do not, in particular a lot of cellular telephones that include a digital camera. What is clearly needed is a detachable viewfinder for such devices, that may be added at times of need, and may be detached when not needed.

### BRIEF SUMMARY OF THE INVENTION

In one embodiment of the invention a viewfinder is provided comprising a planar base having an upper and a lower surface, a pin affixed in the lower surface of the planar base, the pin having an axis extending substantially at a right angle to the plane of the base, the pin having a diameter and a length to fit in an audio port of a cellular telephone, a planar vertical element joined at substantially a right angle to one end of the planar base, the vertical element extending in the same direction as the axis of the pin, and a viewport affixed to the upper surface of the planar base, the viewport having a central axis extending substantially parallel to the upper surface of the planar base, the axis oriented in a direction at a right angle to the plane of the planar vertical element.

In one embodiment the planar vertical element and the planar base are contiguous, providing a fixed dimension from an inner surface of the planar vertical element to the axis of the pin. Also in one embodiment the planar vertical element is separate from the planar base, and is joined to the planar base to be translatable in the direction of the central axis of the viewport. Also in one embodiment the planar vertical element is spring loaded toward the planar base.

In one embodiment the viewport is a cylindrical tubular element affixed to the planar base. In another embodiment the viewport is a tubular element having a square or a rectangular cross-section. In one embodiment the viewfinder may be a thin ring. In another embodiment the viewfinder is a cylindrical tube comprising one or more lenses providing focus or magnification.

In another aspect of the invention a method is provided, comprising: providing a viewfinder having a planar base having an upper and a lower surface, a pin affixed in the lower surface of the planar base, the pin having an axis extending substantially at a right angle to the plane of the base, the pin having a diameter and a length to fit in an audio port of a cellular telephone, a planar vertical element joined at substantially a right angle to one end of the planar base, the vertical element extending in the same direction as the axis of the pin, and a viewport affixed to the upper surface of the planar base, the viewport having a central axis extending substantially parallel to the upper surface of the planar base, the axis oriented in a direction at a right angle to the plane of the planar vertical element, engaging the pin in an audio port of a cellular telephone, causing an inside surface of the vertical element to contact a flat surface of the cellular telephone, causing the viewport to orient at substantially a right angle to the plane of the flat surface of the cellular telephone, and looking through the viewport to frame an image for an image-capturing device of the cellular telephone.

In one embodiment of the method the planar vertical element and the planar base are contiguous, providing a fixed dimension from an inner surface of the planar vertical element to the axis of the pin. In an alternative embodiment the planar vertical element is separate from the planar base, and is joined to the planar base to be translatable in the direction of the central axis of the viewport. Still in one embodiment the planar vertical element is spring loaded toward the planar base.

In some embodiments the viewport is a cylindrical tubular element affixed to the planar base. In some other embodiments the viewport is a tubular element having a square or a rectangular cross-section. In some embodiments the viewfinder may be a thin ring. In some embodiments the viewfinder is a cylindrical tube comprising one or more lenses providing focus or magnification.

### BRIEF DESCRIPTION OF THE SEVERAL VIEWS OF THE DRAWINGS

FIG. 1 is a perspective view of a digital camera with a detachable viewfinder according to one embodiment of the present invention.

FIG. 2 is a perspective view of a digital camera with a detachable viewfinder according to another embodiment of the present invention.

FIG. 3a is a perspective view of a folding, or “flip” phone with a detachable viewfinder in an embodiment of the present invention.

FIG. 3b shows the phone and viewfinder of FIG. 3a fully engaged.

FIG. 3c is a cross-section through a portion of the structure of the viewfinder in FIG. 3a.

FIG. 4 illustrates another viewfinder in an embodiment of the present invention.

FIG. 5a is a front elevation view of a cellular telephone known in the art.

FIG. 5b is a top view of the cellular telephone of FIG. 5a.

FIG. 6a is a side view of the cellular telephone of FIGS. 5a and b with a viewfinder attached in an embodiment of the invention.

FIG. 6b is a front view of the arrangement of FIG. 6a.

FIG. 7a is a side elevation view of the viewfinder in FIGS. 6a and 6b, detached from the cellular telephone, in an embodiment of the invention.

FIG. 7b is a front elevation view of the viewfinder of FIG. 7a.

FIG. 8 is a side elevation view of a viewfinder in an embodiment of the invention, with a translatable vertical planar element.

FIG. 9 is a side elevation view of a viewfinder in an embodiment of the invention with lenses in the viewport for focus or magnification.

### DETAILED DESCRIPTION OF THE INVENTION

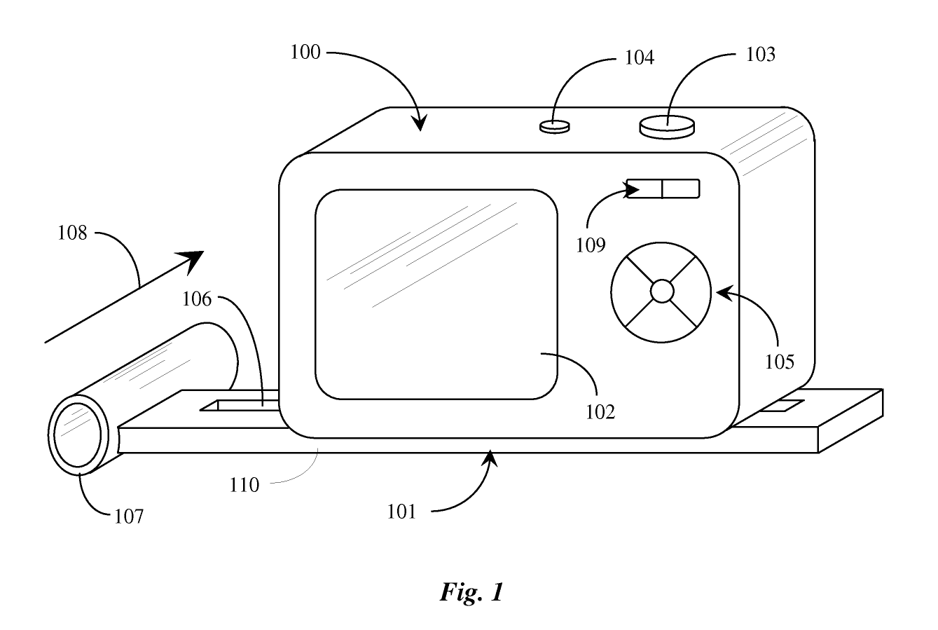

FIG. 1 is a perspective view of a digital camera 100 with a detachable viewfinder 101 according to one embodiment of the present invention. Camera 100 in this example is directed for image capture in the direction of arrow 108, and has a button 103 for activating capture of a still image or for initiating frame capture for video. A smaller button 104 is for extending a lens mechanism, not shown as it is on the opposite side of the camera. There is in addition a button set 109 for zooming in or out with the lens mechanism. A button set 105 is for moving a cursor in a digital display 102 or for moving left, right, up or down among menu selections.

Detachable viewfinder 101 in this example has a long body 110 with a lengthwise slot 106 for engaging camera 100 by a threaded hole in the bottom of the camera (not shown) which is provided in the camera for attaching the camera to a tripod assembly. A thumb screw passes from below through slot 106 and is threaded into the threaded hole in the bottom of the camera.

A cylindrical eyepiece 107 is attached to body 106 at one end such that the axis of the cylinder is generally in the direction of arrow 108. This attachment may be by welding or soldering, for example, or by other conventional means. In some cases the angle of the cylinder of the cylinder of the eyepiece may be angled slightly vertically and horizontally to account for parallax so that the eyepiece cylinder and the camera lens may intersect at a desired distance. In some cases the cylindrical eyepiece may be adjustable in angle over a small rotational range so parallax may be adjusted as well.

In some embodiments the cylindrical eyepiece may be attached at the end of body 110 opposite to that shown in FIG. 1. In some other embodiments there may be a cylindrical eyepiece attached at both ends of the body, and the user may choose which eyepiece to use.

It will be apparent to the skilled person that the representation of a digital camera in FIG. 1 is exemplary only, and is meant to represent a range of different devices, many of which will have features different than those shown in this example. The camera represented is meant to represent any such camera or other image capturing device that has a threaded hole in the base for attaching to a tripod, as is common among such devices. The device need not be digital.

It will also be apparent to the skilled person that the length of body 110 and of slot 106 may vary considerably in different versions of a detachable viewfinder, allowing the cylindrical eyepiece to be set at varying distances from the camera to which it joined. Further cylindrical eyepiece 107 may vary in outside and inside diameter, and in length. In some cases the eyepiece is a simple mechanical cylinder, but in other cases there may be lenses in the cylinder. In other cases the eyepiece may be other than cylindrical, such as square or rectangular in cross-section. There are many possibilities.

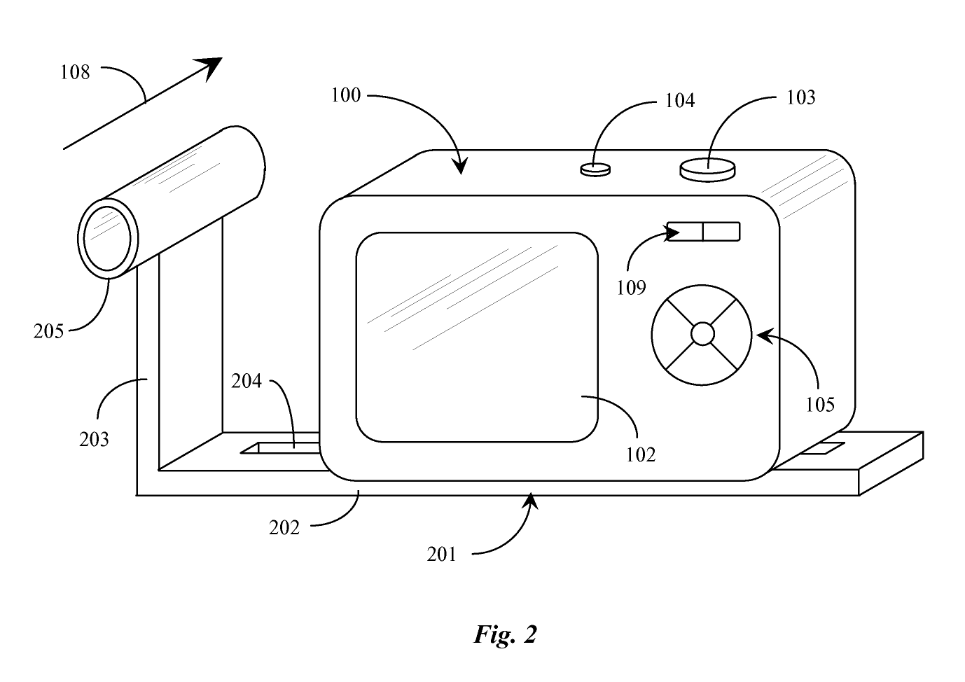

FIG. 2 is a perspective view of a digital camera 100 with a detachable viewfinder 201 according to another embodiment of the present invention. Camera 100 is the same as in FIG. 1, and is meant to represent any image-capturing device that has a threaded hole in the base for attaching to a tripod.

Detachable viewfinder 201 has an extended base 202 with a lengthwise slot 204 for engaging camera 100. A second extension 203 proceeds at substantially a right angle to base 202 in this example, and a cylindrical eyepiece 205 is attached at an upper end of extension 203. The right-angle extension allows eyepiece 205 to present at a different aspect relative to the lens mechanism (not shown) of camera 100, and to afford a different geometry for a user. As described with reference to FIG. 1, the eyepiece may have other shape than the cylinder shown, and may be mechanical, or may have lenses. The height of extension 203 may differ in different embodiments, and the angle of extension 203 with base 202 may be other than ninety degrees. The length of base 202 and slot 204 may be different in different embodiments, such that the eyepiece might be immediately adjacent the camera, or at some distance from the camera. As before, the angle of attachment of the eyepiece to extension 203 may vary to adjust for parallax. In some cases extension 203 and base 202 may be joined by fasteners, and therefore detachable as well, and the eyepiece might be joined to either upward extension 203, or to base 202. In some cases there may be an upward extension 203 at either end, or both ends, of base 202, and there may be two eyepieces.

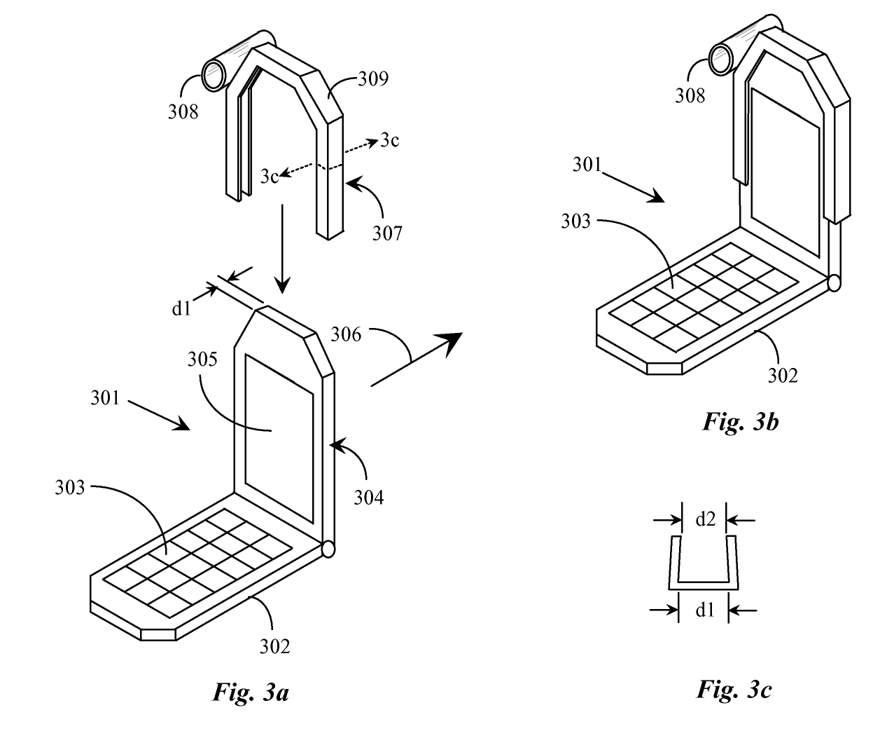

FIG. 3a is a perspective view of a folding, or “flip” phone 301, with a detachable viewfinder 307 in an embodiment of the present invention. The detachable viewfinder in this example is shown detached above the flip phone, with an arrow showing the direction of engagement. FIG. 3b shows phone 301 with the viewfinder fully engaged.

Referring back to FIG. 3a, phone 301 has a base 302 with an I/O keypad 303 as is known in the art, and a folding portion 304 having a display 305 as is also known in the art. Viewfinder 307 in this embodiment has a U-shaped structure 309 formed in a manner to engage the upper part of folding portion 304 of phone 301. FIG. 3c is a cross-section through structure 309 taken along line 3c-3c in FIG. 3a. In one embodiment the side panels of the groove are angled slightly inward as shown, such that d1 in FIG. 3 is d1 in FIG. 3a, that is, the thickness of folding portion 304; but d2 in FIG. 3 is somewhat less than d1 due to the slight inwardly angled sidewalls of the groove.

In many embodiments folding portion 304 is molded of a plastic material that is flexible when finished, such that, as viewfinder 307 engages folding portion 304 the sidewalls that are separated at the dimension d2 expand to d1 so that the engagement may take place, and the flexing of the material provides a force against the opposite surfaces of folding portion 304 to hold the viewfinder in place once engaged.

Viewfinder 307 has an eyepiece 308 attached at a convenient location as shown in FIG. 3a, such that with the viewfinder engaged to the folding portion the eyepiece is convenient for the user to see the field that will be captured when the camera is triggered to capture an image. As described above, eyepiece 308 may be joined to structure 309 at an angle to account for parallax. Further, in some embodiments the eyepiece may be adjustable for this angle if needed, and in some embodiments the eyepiece may be moved from one location to another on structure 307. Further, there may be more than one eyepiece, and the eyepiece need not be cylindrical as shown, but may have other shape, and in some cases may have a lens or lenses as well.

Further to the above, in some cases upper portion 304 of phone 301 may have one or more buttons or connectors in the edge region that might be covered when the viewfinder is engaged. In some cases structure 307 may be molded to provide openings for such connectors or buttons. In some cases one viewfinder may serve for two or more telephones, but some telephones may require a dedicated detachable viewfinder, which may be bundled with the phone when sold, or purchased separately.

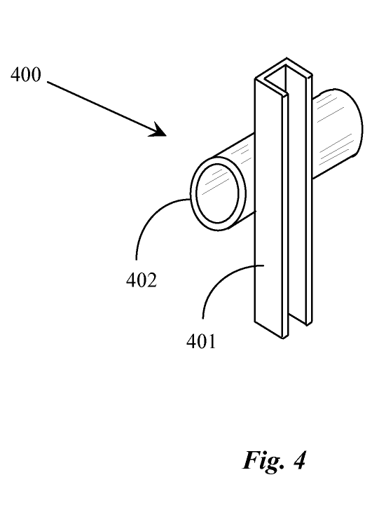

It will be apparent to the skilled person that viewfinder 307 may engage telephones and/or other devices including image-capture mechanisms and systems, other than flip-phones as shown. It will further be apparent that the same principles may be used to provide a viewfinder with an eyepiece attached to a single straight piece of molded material, such as is shown in FIG. 4, which illustrates a viewfinder 400 according to an embodiment of the invention, having a straight grooved portion 401 and an attached eyepiece 402. This embodiment is more universally adaptable to various existing commercial devices that have image-capture capability, because only one edge of such a device need be engaged. In this version as in others, the eyepiece may be cylindrical, as shown, or may have other shape or have lenses.

In one version of the detachable viewfinder 400, the width at the bottom of the groove is made rather large, and the angle of one or both sidewalls inward is made rather more acute than as shown in FIG. 3c, so the one viewfinder might be used an a variety of devices of varying thickness. Further still, the length of portion 401 may be rather short, such as 0.5 inches, so there is a greater freedom of placement along the edge of a device to which the viewfinder may be engaged.

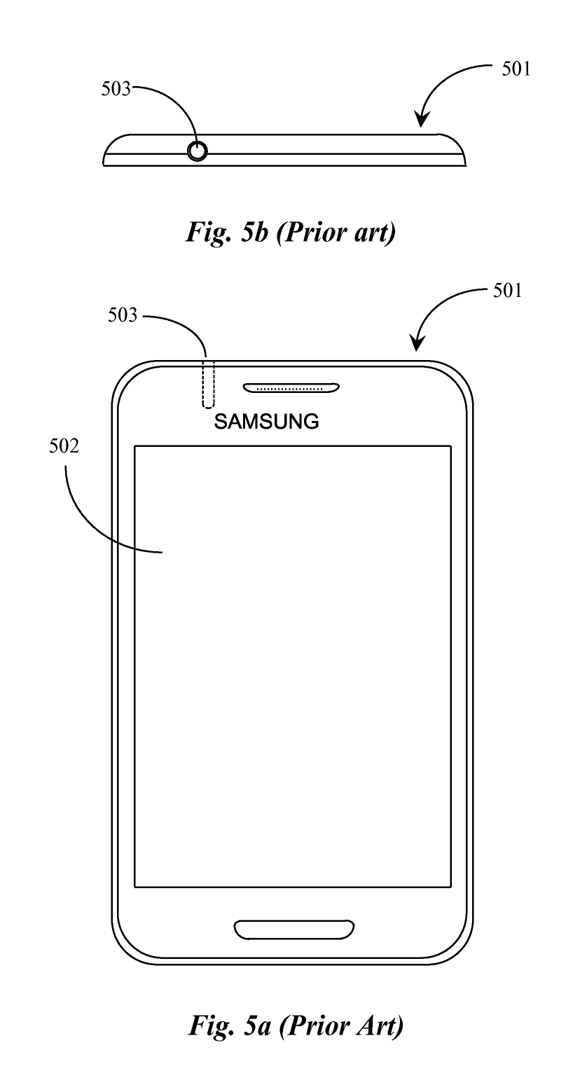

In another aspect of the invention a viewfinder is provided that engages to a cellular telephone at a port of the telephone. FIG. 5a is a front elevation view of a cellular telephone 501 known in the art, having a display screen 502 and an electronic port 503 for engaging a jack of a headphone or headset to monitor audio in transactions processed by the cellular telephone. FIG. 5b is a top view of cellular telephone 501 showing port 503 from the top. The skilled artisan will understand that there are a variety of makes and models of cellular telephones in the art that have a port analogous to port 503. In some cases the port may be on one side or the other of a body portion of the telephone, and in some cases the telephone may have more than one body portion, such as the well-known type known as a flip phone. In substantially all cases, however, the port for a headphone or earphone jack will be of a standard diameter and depth, and the axis of the port will be in a direction substantially parallel to the planar aspect of the body portion in which the port is implemented.

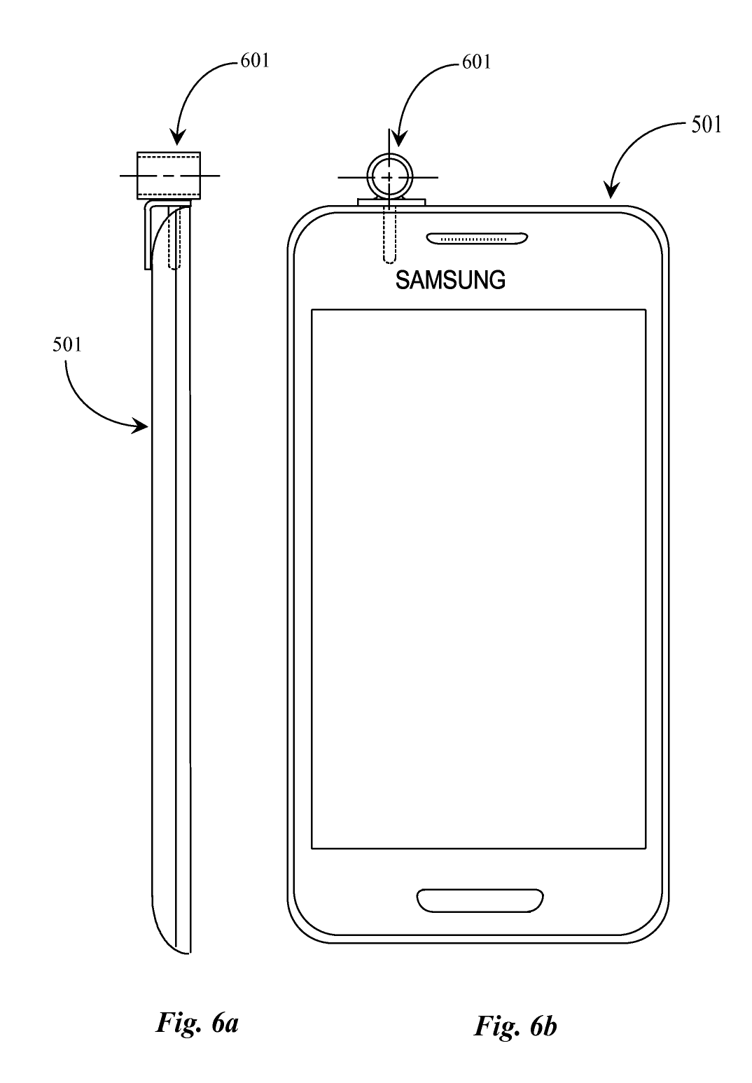

FIG. 6a illustrates the cellular telephone of FIGS. 5a and 5b with a viewfinder 601 engaged in port 503 according to an embodiment of the invention. FIG. 6b illustrates the telephone and engaged viewfinder from a front elevation view. The viewfinder is in this example a tube with an axis orthogonal to the plane of the flat aspect of the cellular telephone. A user, determined to capture photos with the telephone, perhaps in a sunny environment where the display of the image apparatus may not be easily viewed, may engage the tubular viewfinder, and easily orient the telephone properly to capture desired views.

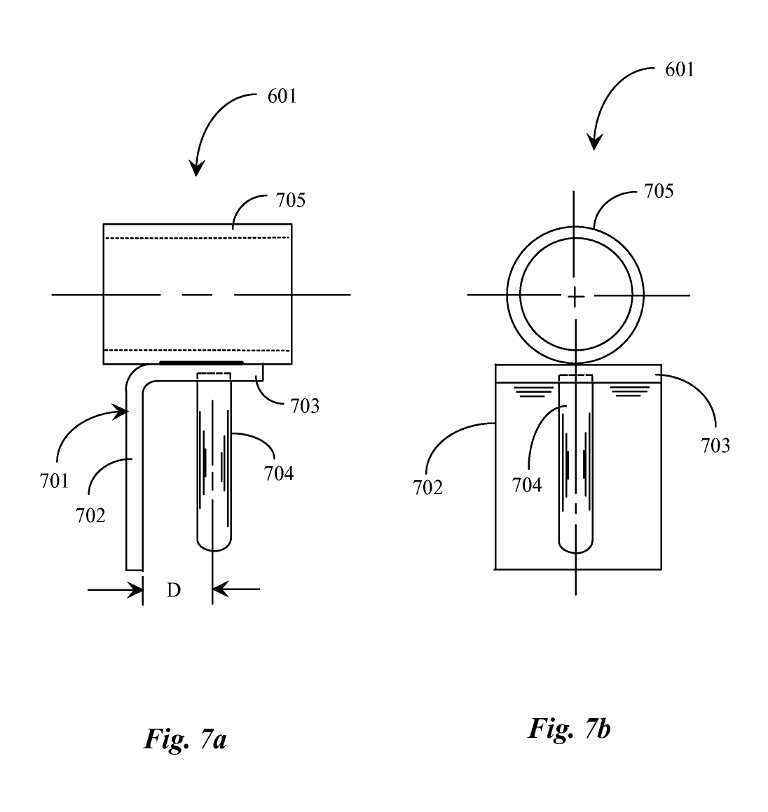

FIG. 7a is a side elevation view of viewfinder 601 of FIGS. 6a and 6b, and FIG. 7b is a front elevation view of the viewfinder. In this example viewfinder 601 comprises a base element 701 which is formed with two planar portions at right angles. Planar portion 703 provides a horizontal base for supporting a tubular viewport 705 and an engagement pin 704. Viewport 705 is shown with a particular length, but may be longer of shorter than shown, and may be very short. Engagement pin 704 is provided in a diameter and length that will fit snugly into electronic port 503 of the cellular telephone, and is engaged to planar portion 703 by a tight fit opening on the underside of the planar portion, so there will be no impediment to the pin fully engaging port 703 allowing planar portion 703 to rest on the edge of the cellular telephone. Planar portion 702 provides a vertical surface at a dimension D from the centerline of engagement pin 704, such that the inner surface of planar portion 702 will engage a flat surface of the cellular telephone, providing for orientation of the axis of viewport 705 at a right angle to the flat surface of the cellular telephone.

In the example of FIGS. 7a and 7b the viewfinder is provided to accommodate a particular make and model of a cellular telephone, having a particular dimension D between the axis of port 503 and the flat surface of the telephone. This dimension might be common to more than one make and model of cellular telephone.

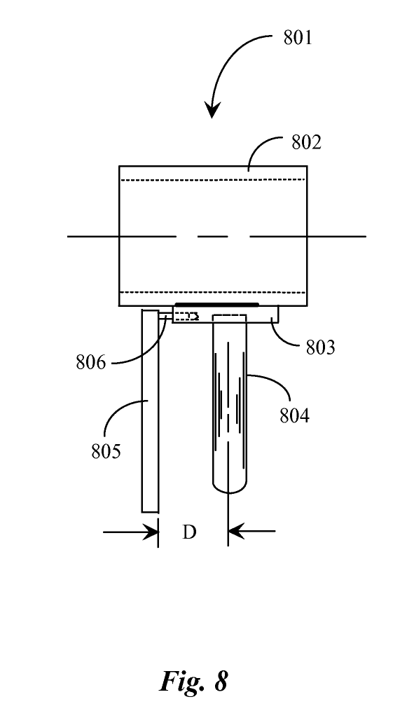

In an alternative embodiment adjustable elements are provided to make the viewfinder in an embodiment of the invention adaptable to a broader number of cellular telephones. FIG. 8 illustrates a viewfinder 801 having a viewport 802 and a base 803 analogous to planar portion 702 of FIGS. 7a and 7b. The viewport is affixed to the base just as in the embodiment of FIGS. 7a and 7b, and may be of any convenient length, including very short.

Vertical planar portion 805 is provided separate from base 803 in this embodiment, and engages horizontal base 803 by one or more pins 806 that engage holes in base 803 such that vertical planar portion 805 is translatable toward and away from pin 804. The fact of being thus translatable provides that viewfinder 801 may be used with a wide variety of cellular telephones.

It will be apparent to the skilled person that there are several ways that the vertical planar element may be made translatable, and in some variations the element may be spring-loaded toward pin 804.

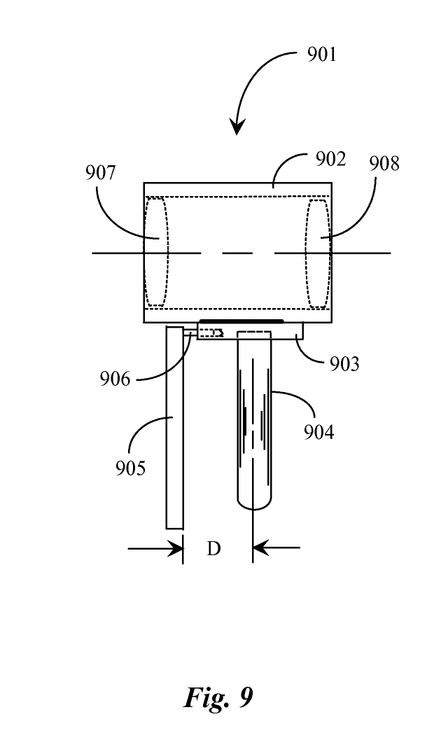

In yet another aspect a viewfinder may be provided in an embodiment of the present invention with lenses in a tubular viewport, as shown in FIG. 9. In the embodiment of FIG. 9 viewfinder 901 has a base 903 and a pin 904, as well as a translatable portion 905 as in the embodiment shown in FIG. 8. But viewport 902 has lenses 907 and 908 that may be provided for any convenient magnification or focal length. Lenses may also be provided in the viewport that is designed as in FIG. 6 without adjustment.

It will be apparent to the skilled artisan that the viewfinders taught in the disclosure above and the several figures provided may be manufactured of a variety of materials, and may be made in a variety of geometries as well, without departing from the spirit and scope of the invention. Further, the attachment mechanisms taught may have broader implementation as well. For example, referring to FIG. 4, rather than have angled sidewalls that may be flexed, a straight grooved portion may be provided with a spring-loaded mechanism to grip the thickness of a device having image-capture capability. In some embodiments there may be additional material added at the surfaces where a mechanism impinges on the surface of a telephone or other device. Such material, for example, may be such as to prevent marking or marring the surface of the device, or may be to enhance the gripping capability. Material may also be added for aiding the grip of the person using the device with the detachable viewfinder.

In regard to the viewfinders described with reference to FIGS. 6-9, and other viewfinders described above as well, the viewports are shown as tubular or at least circular in nature. This is not a limitation, as viewports may be square or rectangular in aspect, and are not limited as to their particular shape. There are many possibilities.

1. A viewfinder comprising:
a planar base having a length, a width and an upper and a lower surface;
a pin affixed in the lower surface of the planar base at a position centered on the width of the planar base, the pin having an axis extending substantially at a right angle to the plane of the planar base, the pin having a diameter and a length to fit into an audio port of a device having imaging capability;
two sidewalls, one on each side of the width of the planar base, the sidewalls extending in the same direction as the axis of the pin and angled inward from the width of the planar base such that the separation of the sidewalls at an extremity away from the planar base is less than the width of the planar base; and
a viewport affixed to the upper surface of the planar base, the viewport having a central axis extending substantially parallel to the upper surface of the planar base, the axis oriented in a direction at a right angle to the length of the planar base.

2-4. (canceled)

5. The viewfinder of claim 1 wherein the viewport is a cylindrical tubular element affixed to the planar base.

6. The viewfinder of claim 1 wherein the viewport is a tubular element having a square or a rectangular cross-section.

7. The viewfinder of claim 1 wherein the viewfinder is a thin ring.

8. The viewfinder of claim 1 wherein the viewfinder is a cylindrical tube comprising one or more lenses providing focus or magnification.

9. A method comprising:
providing a viewfinder having a planar base having a length, a width and an upper and a lower surface, a pin affixed in the lower surface of the planar base at a position centered on the width of the planar base, the pin having an axis extending substantially at a right angle to the plane of the planar base, the pin having a diameter and a length to fit into an audio port of a device having imaging capability, two sidewalls, one on each side of the width of the planar base, the sidewalls extending in the same direction as the axis of the pin and angled inward from the width of the planar base such that the separation of the sidewalls at an extremity away from the planar base is less than the width of the planar base, and a viewport affixed to the upper surface of the planar base, the viewport having a central axis extending substantially parallel to the upper surface of the planar base, the axis oriented in a direction at a right angle to the length of the planar base;
engaging the pin in an audio port of a device having imaging capability, causing the sidewalls to flex outwardly and to grip opposite sides of the device, and causing the viewport to orient at substantially a right angle to the length of the planar base; and
looking through the viewport to frame an image for an image.

10-12. (canceled)

13. The method of claim 9 wherein the viewport is a cylindrical tubular element affixed to the planar base.

14. The method of claim 9 wherein the viewport is a tubular element having a square or a rectangular cross-section.

15. The method of claim 9 wherein the viewfinder is a thin ring.

16. The method of claim 9 wherein the viewfinder is a cylindrical tube comprising one or more lenses providing focus or magnification.
